(19) United States
(12) Patent Application Publication
(10) Pub. No.: US 2021/0304194 A1
(43) Pub. Date: Sep. 30, 2021

(54) WALLET SERVER, WALLET PROGRAM, AND WALLET SYSTEM

(71) Applicant: TOYOTA JIDOSHA KABUSHIKI KAISHA, Toyota-shi (JP)

(72) Inventors: Kenichi YAMADA, Nisshin-shi (JP); Tadaaki SAKAMOTO, Tokyo (JP); Yuma HAYASHIDA, Tokyo (JP); Masatoshi ISHIZUKA, Tokyo (JP); Mika TAKAKI, Tokyo (JP); Takuya KAGA, Mitaka-shi (JP); Tetsuya SAKAI, Tokyo (JP); Tsukasa KARASAWA, Nagoya-shi (JP)

(73) Assignee: TOYOTA JIDOSHA KABUSHIKI KAISHA, Toyota-shi (JP)

(21) Appl. No.: 17/205,160

(22) Filed: Mar. 18, 2021

(30) Foreign Application Priority Data
Mar. 26, 2020 (JP) 2020-056867

(51) Int. Cl. G06Q 20/36; G06Q 20/02; G06Q 20/22; G06Q 20/40; G06Q 40/02

(52) U.S. Cl. CPC G06Q 20/3676; G06Q 20/02; G06Q 40/02; G06Q 20/4037; G06Q 20/407; G06Q 20/29

(57) ABSTRACT

A processor having hardware is provided. The processor creates, when the processor receives a creation request of group payment means for making a payment by electronic money using a first terminal and a second terminal that are associated with an organizer and a participant of a group, respectively, the group payment means in a wallet in which a plurality of payment means is registrable. The processor outputs a deposit request to a first server designated in the creation request, based on registration information of the group payment means acquired from the second terminal, to a second server designated in the registration information.

### CROSS-REFERENCE TO RELATED APPLICATION

This application claims priority to Japanese Patent Application No. 2020-056867 filed on Mar. 26, 2020, incorporated herein by reference in its entirety.

### BACKGROUND

### 1. Technical Field

The present disclosure relates to a wallet server, a wallet program, and a wallet system.

### 2. Description of Related Art

There is a known technique capable of visually understanding information on payment by more than one person such as a payment amount when the payment is made by more than one person (see, for example, Japanese Unexamined Patent Application Publication No. 2018-124626 (JP 2018-124626 A).

### SUMMARY

There has been a demand for a technique that can easily make payments when more than one person act as a group.

The present disclosure has been made in view of the above, and an object of the present disclosure is to provide a wallet server, a wallet program, and a wallet system that can easily make a payment when more than one person act in a group.

A wallet server according to the present disclosure includes a processor including hardware. The processor creates, when the processor receives a creation request of group payment means for making a payment by electronic money using a first terminal and a second terminal that are associated with an organizer and a participant of a group, respectively, the group payment means in a wallet in which a plurality of payment means is registrable, and outputs a deposit request to a first server designated in the creation request, based on the registration information of the group payment means acquired from the second terminal, to a second server designated in the registration information.

A wallet program according to the present disclosure causes a processor including hardware to perform: creating, when the processor receives a creation request of group payment means for making a payment by electronic money using a first terminal and a second terminal that are associated with an organizer and a participant of a group, respectively, the group payment means in a wallet in which a plurality of payment means is registrable; and outputting a deposit request to a first server designated in the creation request, based on registration information of the group payment means acquired from the second terminal, to a second server designated in the registration information.

A wallet system according to the present disclosure includes: a wallet server including a first processor having hardware; a first server including a second processor having hardware; and a second server including a third processor having hardware. The first processor creates, when the processor receives a creation request of group payment means for making a payment by electronic money using a first terminal and a second terminal that are associated with an organizer and a participant of a group, respectively, the group payment means in a wallet in which a plurality of payment means is registrable; and outputs a deposit request to a first server designated in the creation request, based on the registration information of the group payment means acquired from the second terminal, to a second server designated in the registration information.

According to the present disclosure, it is possible to easily make a payment when more than one person act as a group.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing an overall configuration of a wallet system according to an embodiment of the present disclosure;

FIG. 2 is a diagram schematically showing a functional configuration of the wallet system according to the embodiment of the present disclosure;

FIG. 3 is a sequential diagram showing an outline of processing at the start of a group pay executed by the wallet system according to the embodiment of the present disclosure;

FIG. 4 is a diagram showing a display example of an initial screen of a wallet on a display unit of a first terminal after the start of the group pay;

FIG. 5 is a sequential diagram showing an outline of payment processing executed by the wallet system according to the embodiment of the present disclosure using the group pay;

FIG. 6 is a sequential diagram showing an outline of additional collection processing executed by the wallet system according to the embodiment of the present disclosure using the group pay; and

FIG. 7 is a sequential diagram showing an outline of termination processing executed by the wallet system according to the embodiment of the present disclosure using the group pay.

### DETAILED DESCRIPTION OF EMBODIMENTS

Hereinafter, modes for carrying out the present disclosure (hereinafter, referred to as “embodiments”) will be described with reference to the accompanying drawings.

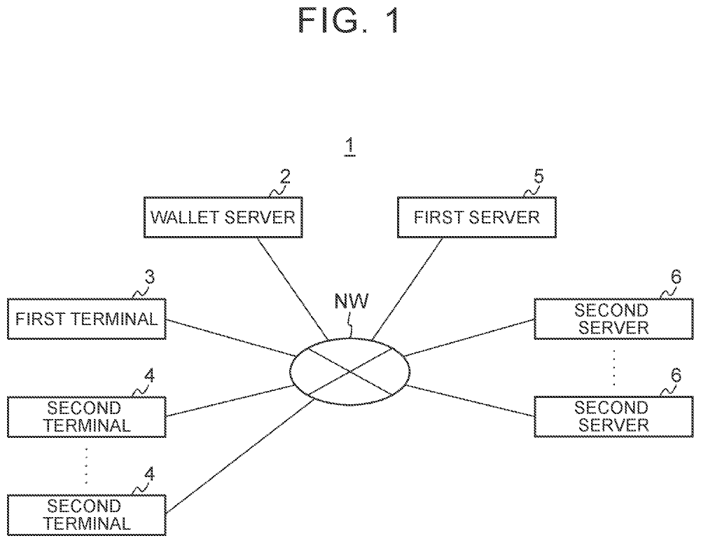

FIG. 1 is a diagram schematically showing an overall configuration of a wallet system according to an embodiment of the present disclosure; A wallet system 1 shown in FIG. 1 includes a wallet server 2, a first terminal 3, a plurality of second terminals 4, a first server 5, and a plurality of second servers 6. The wallet server 2, the first terminal 3, the second terminals 4, the first server 5, and the second servers 6 can communicate with each other through a network NW. The network NW is composed of, for example, an Internet network, a mobile phone network, etc. in which wired and wireless communications are appropriately combined.

The first server 5 and the second servers 6 are servers managed by different payment service providers (financial institutions or credit card companies), and receive payment requests from a user via the wallet server 2. In other words, the wallet system 1 is a system that allows the user to select a payment method when making a payment using electronic money.

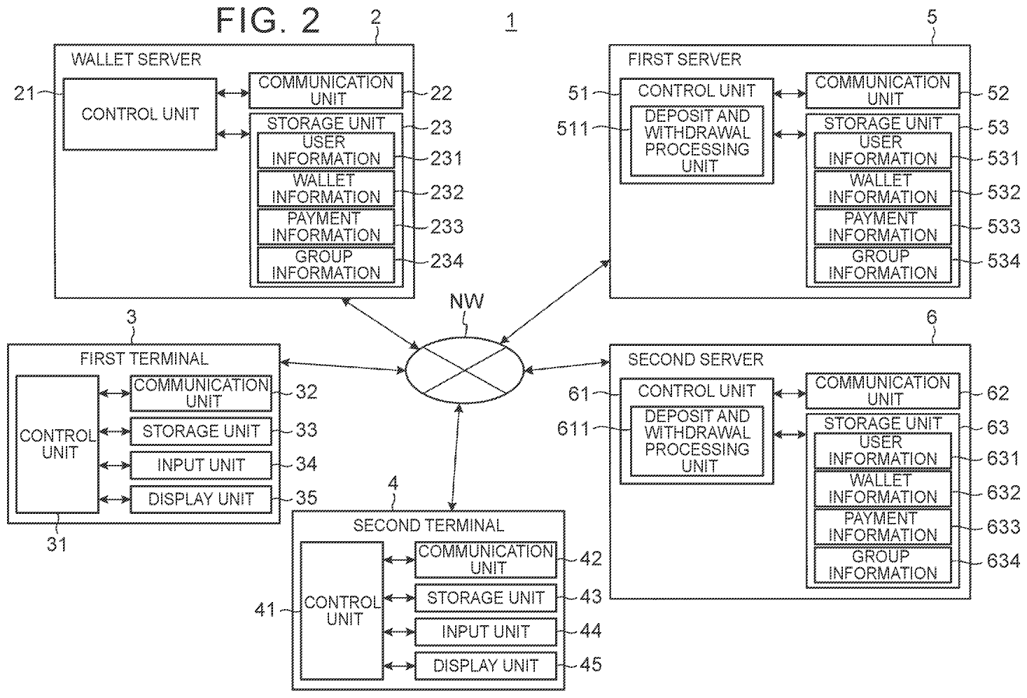

FIG. 2 is a block diagram showing a functional configuration of the wallet system 1. Hereinafter, the functional configuration of the wallet system 1 will be described with reference to FIG. 2. FIG. 2 shows one of the second terminals 4 and one of the second servers 6 as representatives.

First, the wallet server 2 will be described. The wallet server 2 includes a control unit (first processor) 21, a communication unit 22, and a storage unit 23.

The control unit 21 controls operations of the wallet server 2 in a centralized manner. The control unit 21 updates a deposit amount of group information 234 stored in the storage unit 23 every time payment by a group wallet is made, and outputs and transmits a deposit request to the second server 6 when the deposit amount falls below a predetermined amount (hereinafter simply referred to as “transmit a request”). Further, when the control unit 21 receives and acquires a payment request from the first terminal 3 (hereinafter, simply referred to as “receive a request”), the control unit 21 calculates a payment amount and transmits a payment instruction to the first server 5.

Specifically, the control unit 21 is a processor composed of a central processing unit (CPU), a digital signal processor (DSP), a field-programmable gate array (FPGA), and a memory (main storage unit) composed of a random access memory (RAM) and a read-only memory (ROM), etc. The control unit 21 loads programs stored in the storage unit 23 into a work area of the main storage unit and executes the loaded programs so as to control components of the wallet server 2 through execution of various programs including a wallet program according to the embodiment.

The communication unit 22 is, for example, a local area network (LAN) interface board or a wireless communication circuit for wireless communication. The communication unit 22 is connected to the network NW. The communication unit 22 communicates with the first terminal 3, the second terminals 4, the first server 5, and the second servers 6 by connecting to the network NW under the control of the control unit 21. The program to be executed by the wallet server 2 may be downloadable via the network NW.

The storage unit 23 stores user information 231 and wallet information 232, payment information 233, and the group information 234 for each user registered in the wallet system 1.

The user information 231 is information about the user who uses the wallet system 1. Examples of the user information 231 include a user ID, password, user name, and user contact information (e.g. address, telephone number, and e-mail address) of the user who has registered for use of the wallet system 1 in advance. The user ID and the password in the user information 231 are used during authentication processing such as logging in to the wallet server 2.

The wallet information 232 is information about a wallet of the wallet system 1. The wallet is a virtual deposit and withdrawal account of electronic money. The wallet information 232 includes, for example, a user ID, balance of the electronic money, a deposit history of the electronic money, and a usage history of the electronic money.

The payment information 233 is information related to the payment of the wallet system 1. The payment information 233 includes a user ID, information on a payment service provider used for payment and a payment server corresponding to a payment method, and a payment history.

The group information 234 is information about a group composed of a plurality of users. The group information 234 includes user information of an organizer and participants of the group, information on a server that settles payments by electronic money using a group payment method shared within the group, and information on initial collection amount and a surcharge amount collected from the organizer and the participants of the group, information on a server registered by the participants in the group to process deposits and withdrawals with the payment server in the group payment method, and balance information of the group payment method. The group information 234 also includes information that partially overlaps with the wallet information 232. Hereinafter, the group payment method will be referred to as a “group pay”. In addition, the organizer and the participants of the group are collectively referred to as members of the group.

The storage unit 23 includes, for example, a recording medium such as an erasable programmable ROM (EPROM), a hard disk drive (HDD), and a removable medium. Examples of removable media include disc recording media such as a universal serial bus (USB) memory, a compact disc (CD), a digital versatile disc (DVD), and a Blu-ray (registered trademark) disc (BD). The storage unit 23 stores an operating system (OS), various programs, various tables, and various databases, etc.

The first terminal 3 is a terminal associated with the organizer of the group. The first terminal 3 includes a control unit 31, a communication unit 32, a storage unit 33, an input unit 34, and a display unit 35. The control unit 31, the communication unit 32, and the storage unit 33 are physically configured using the same hardware as the control unit 21, the communication unit 22, and the storage unit 23, respectively.

The input unit 34 is configured using a touch panel. The input unit 34 may have a microphone for voice input. The display unit 35 includes a display made of liquid crystal or organic electroluminescence (EL) on its surface. A touch panel forming the input unit 34 is provided on the surface of the display. Examples of the first terminal 3 include smartphones, mobile phones, tablet terminals, wearable computers, personal computers, and car navigation systems mounted on vehicles. The program to be executed by the first terminal 3 may be provided as an application that is downloadable via the network NW.

The second terminals 4 are terminals associated with the participants other than the organizer of the group. The second terminals 4 each include a control unit 41, a communication unit 42, a storage unit 43, an input unit 44, and a display unit 45. The functional configuration of the second terminals 4 is the same as the functional configuration of the first terminal 3.

The first server 5 is provided in a financial institution (e.g. a bank, a credit union, a credit association, or a labor bank) or a credit card company, and is a server for managing an account or a credit card of the financial institution. The first server 5 includes a control unit (second processor) 51, a communication unit 52, and a storage unit 53. The control unit 51, the communication unit 52, and the storage unit 53 are physically configured using the same hardware as the control unit 21, the communication unit 22, and the storage unit 23, respectively. The first server 5 is a server that manages deposits and withdrawals of the electronic money by at least the first terminal 3, and is a payment server that settles payments by the electronic money of the group pay.

The control unit 51 controls operations of the first server 5 in a centralized manner. The control unit 51 includes a deposit and withdrawal processing unit 511 that performs deposit and withdrawal processing of the electronic money. When the deposit and withdrawal processing unit 511 receives the deposit request or the withdrawal request of the electronic money, the deposit and withdrawal processing unit 511 authenticates validity of the electronic money and performs the deposit and withdrawal processing when the authentication is successful.

The storage unit 53 stores user information 531 and wallet information 532, payment information 533, and the group information 534 for each registered user. The user information 531 includes the user's account information and credit card information. The account information includes, for example, the user's name, account number, account balance, and deposit and withdrawal history. The credit card information includes, for example, the user's name, credit card number, an expiration date of the credit card, usage limit amount, and card usage history. The wallet information 532 is the same information as the wallet information 232 stored in the wallet server 2. The payment information 533 includes a user ID, a payment method used for payment (e.g. payment by the electronic money (non-contact payment), payment by scanning, or payment by code), and payment history. The group information 534 is the same information as the group information 234 stored in the wallet server 2.

The first server 5 having the above functional configuration is realized by a computer such as a workstation or a personal computer.

The second server 6 includes a control unit (third processor) 61, a communication unit 62, and a storage unit 63. The functional configuration of the second server 6 is the same as the functional configuration of the first server 5. The control unit 61 includes a deposit and withdrawal processing unit 611. The storage unit 63 stores user information 631, wallet information 632, payment information 633, and group information 634. The second server 6 is a server that manages the deposit and withdrawal of the electronic money by any one of the first terminal 3 and the plurality of second terminals 4.

In the wallet system 1 having the above functional configuration, the first terminal 3 can make a payment by the electronic money via one or more payment servers including at least the first server 5. In addition, each of the second terminals 4 can make payments by the electronic money via one or more payment servers including at least one of the second servers 6. The user of each terminal makes a payment by the electronic money by selecting a desired payment means from a plurality of payment means registered in the wallet.

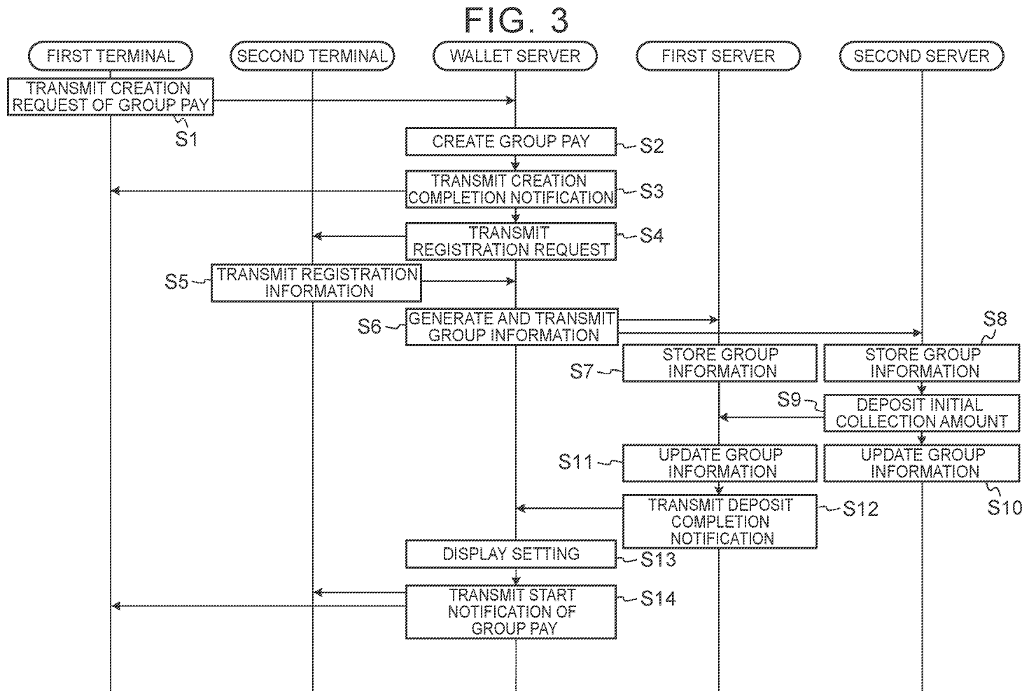

FIG. 3 is a sequential diagram showing an outline of processing at the start of the group pay executed by the wallet system 1. In FIG. 3, it is assumed that the storage unit 23 of the wallet server 2 stores the user information and the payment information of the first terminal 3 and the second terminals 4 in advance. Further, it is assumed that the second servers 6 are servers that handle the payment means used by the second terminals 4 for payment of the group pay. Further, for convenience of explanation, one of the second terminals 4 is used here as a representative. However, when there are two or more participants in the group, the second terminals 4 in the number corresponding to the number of the participants are required, and the first server 5 or the second server 6 is required as a server that handles the payment means used for payment of the group pay by each of the second terminals 4.

First, when the input unit 34 of the first terminal 3 receives a creation request of the group pay, the control unit 31 transmits the creation request to the wallet server 2 via the communication unit 32 (step S1). The creation request includes user information of the members of the group, information for designating the first server 5 as the payment server of the group pay, and information on the initial collection amount to be collected from the members of the group. The members of the group consist of the organizer and the participants of the group.

In the wallet server 2 that has received the creation request, the control unit 21 creates the group pay and registers the created group pay in the group information 234 (step S2). After the step above, the control unit 21 transmits a creation completion notification of the group pay to the first terminal 3 via the communication unit 22 (step S3), and transmits a registration request of the group pay to the second terminal 4 associated with the participant of the group (step S4). When transmitting this registration request, the control unit 21 may also transmit a message of invitation to the group pay.

When the input unit 44 accepts an input of the registration information from the user after the second terminal 4 receives the registration request, the control unit 41 transmits the registration information to the wallet server 2 via the communication unit 42 (step S5). The registration information here includes information on the second server 6 used for deposits to and withdrawals from the first server 5 in the group pay. Note that, the participant of the group may designate the first server 5 as the server used for deposits and withdrawals.

The wallet server 2 that has received the registration information generates the group information related to the group pay, stores the generated group information in the storage unit 23, and transmits the generated group information to the first server 5 and the second server 6 (step S6). This group information includes user information of the members of the group and information of the first server 5 and the second server 6 that mutually perform “deposits and withdrawals” of the group pay.

The first server 5 and the second server 6 that have received the group information store the received group information as the group information 534 and the group information 634 in the storage units 53, 63, respectively (steps S7 and S8).

After the steps above, the deposit and withdrawal processing unit 611 of the second server 6 deposits the electronic money corresponding to the initial collection amount to the first server 5 based on the group information 634 (step S9), and updates the payment information 533 and the group information 534 (step S10).

In the first server 5, when the deposit from the second server 6 is completed, the control unit 51 updates the group information 534 (step S11), and transmits a deposit completion notification to the wallet server 2 via the communication unit 52 (step S12). When there are two or more participants in the group, the control unit 51 transmits the deposit completion notification at the timing when the deposit for all the participants is completed.

The control unit 21 of the wallet server 2 that has received the deposit completion notification from the first server 5 executes display setting to display the group pay as well as other registered payment means when a wallet screen is opened on the first terminal 3 and the second terminal 4 (step S13).

After that, the control unit 21 transmits a start notification of the group pay to the first terminal 3 and the second terminal 4 via the communication unit 22 (step S14).

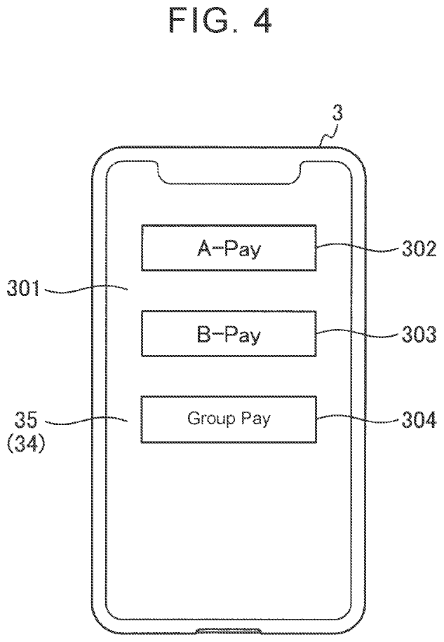

FIG. 4 is a diagram showing a display example of the initial screen of the wallet on the display unit 35 of the first terminal 3 after the start of the group pay. As shown in FIG. 4, on an initial screen 301, a group pay icon 304 is displayed in addition to the other payment means icons 302, 303 that are selectable in the wallet. When the user touches the icon 304, the input unit 34 accepts the input and transitions to a group pay screen. The same initial screen is displayed on the display unit 45 of the second terminal 4 after the start of the group pay.

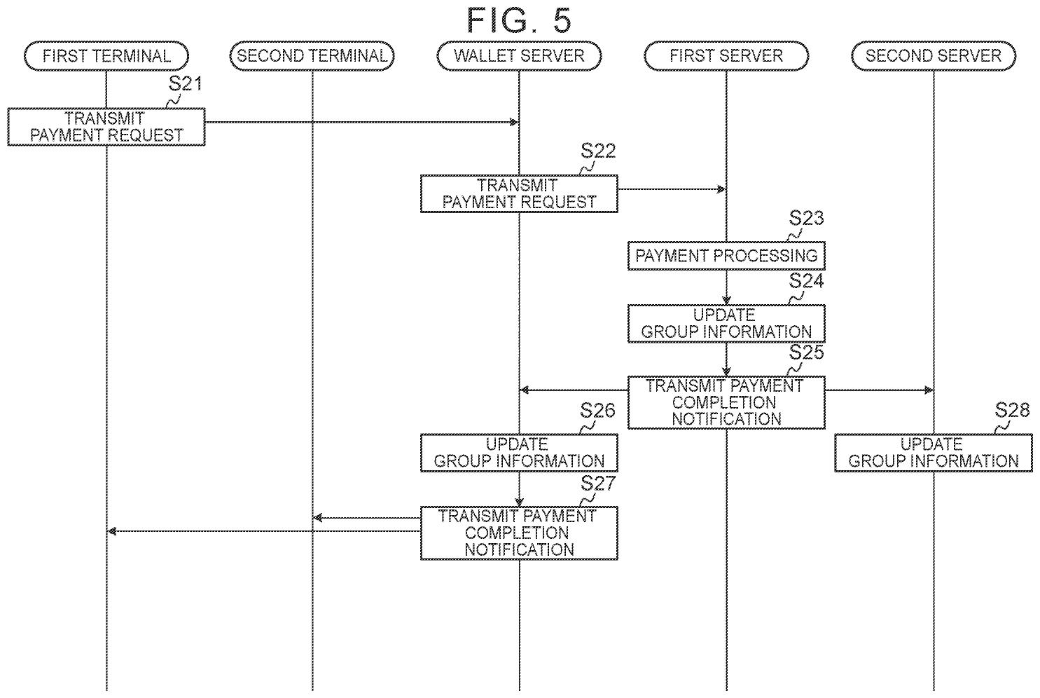

Next, the outline of the payment processing executed by the wallet system 1 using the group pay will be described with reference to the sequence diagram of FIG. 5. In FIG. 5, similar to FIG. 3, it is assumed that the second server 6 is a server that handles the payment means used by the second terminal 4 for making payment using the group pay. Further, for convenience of explanation, one of the second terminals 4 will also be used here as a representative.

First, when the input unit 34 of the first terminal 3 accepts an input of the payment request by the electronic money using the group pay, the control unit 41 transmits the payment request to the wallet server 2 via the communication unit 42 (step S21). The input unit 44 of the second terminal 4 can also accept the input of the payment request. With the processing above, any member of the group can make a payment using the group pay.

The control unit 21 of the wallet server 2 that has received the payment request executes authentication based on the payment request. When the authentication is successful, the control unit 21 transmits the payment request to the first server 5 via the communication unit 22 (step S22). When the control unit 21 executes authentication, the control unit 21 determines validity of the payment request with reference to the payment information 233 and the group information 234. This determination of validity includes a determination of validity of the first terminal 3 and a determination of whether the payment amount is an amount that payment can be made with the balance of the group pay at that time. When the control unit 21 fails in authentication, the control unit 21 transmits a message to the first terminal 3 notifying that the authentication has failed.

The deposit and withdrawal processing unit 511 of the first server 5 that has received the payment request executes authentication based on the payment request. When the authentication is successful, the deposit and withdrawal processing unit 511 executes the payment processing (step S23), and updates the group information 534 (step S24). The payment processing here includes, when purchasing a product, for example, processing of depositing the electronic money corresponding to a price of the product to the server managed by a seller of the product. The authentication processing executed by the deposit and withdrawal processing unit 511 is the same as the authentication processing executed by the control unit 21 of the wallet server 2.

After step S23, the control unit 21 transmits the payment completion notification to the wallet server 2 and the second server 6 via the communication unit 22 (step S25). The payment completion notification includes, for example, information such as the balance after payment by the group pay.

The control unit 21 of the wallet server 2 that has received the payment completion notification updates the group information 234 based on the payment completion notification (step S26), and transmits the payment completion notification to the first terminal 3 and the second terminal 4 via the communication unit 22 (step S27).

Further, the control unit 61 of the second server 6 that has received the payment completion notification updates the group information 634 based on the payment completion notification (step S28).

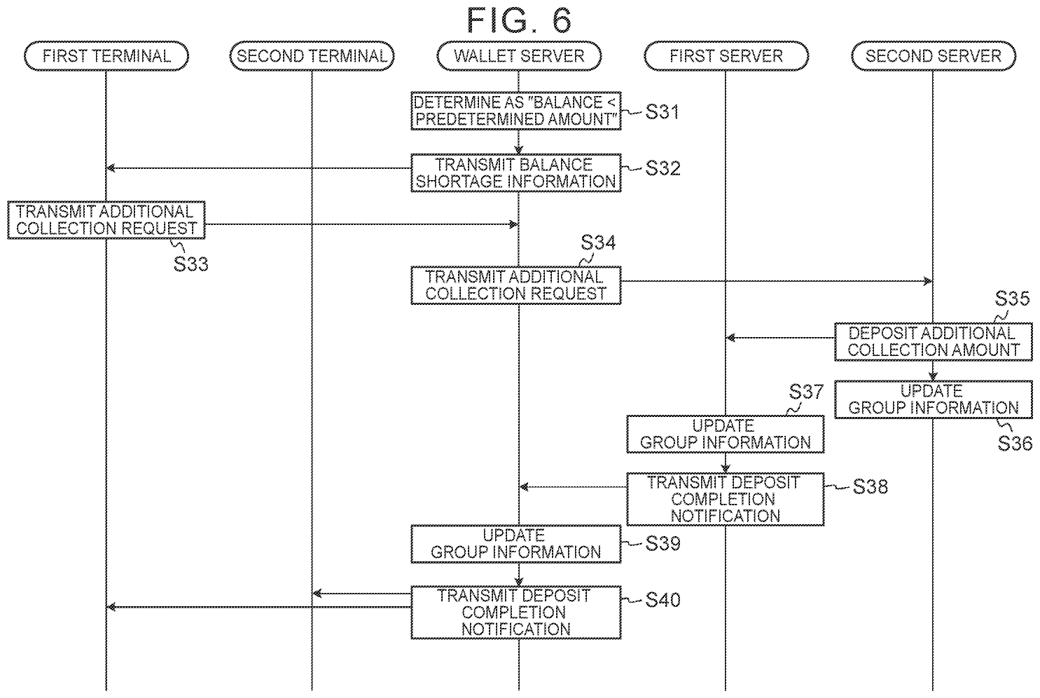

Next, the outline of additional collection processing executed by the wallet system 1 using the group pay will be described with reference to the sequential diagram of FIG. 6. The additional collection processing is processing of collecting additional electronic money from the participants of the group when the balance of the group pay becomes low. In FIG. 6, similar to FIG. 3, it is assumed that the second server 6 is a server that handles the payment means used by the second terminal 4 for making payment using the group pay. Further, for convenience of explanation, one of the second terminals 4 will also be used here as a representative.

First, when the control unit 21 determines that the balance of the group pay included in the group information 234 falls below the predetermined amount (step S31), the control unit 21 transmits balance shortage information to the first terminal 3 (step S32).

In the first terminal 3 that has received the additional collection request, the control unit 31 transmits the additional collection request to the wallet server 2 via the communication unit 32 when the input unit 34 receives the input of the additional collection request requesting deposit of an additional collection amount of money (step S33).

The control unit 21 of the wallet server 2 that has received the additional collection request transmits the additional collection request to the second server 6 via the communication unit 22 (step S34).

The deposit and withdrawal processing unit 611 of the second server 6 that has received the additional collection request executes authentication based on the additional collection request. When the authentication is successful, the deposit and withdrawal processing unit 611 deposits the electronic money in the amount corresponding to the additional collection amount with the first server 5 (step S35) and updates the group information 634 (step S36).

In the first server 5, when the deposit from the second server 6 is completed, the control unit 51 updates the group information 534 (step S37), and transmits the deposit completion notification to the wallet server 2 via the communication unit 52 (step S38). When there are two or more participants in the group, the control unit 51 transmits the deposit completion notification at the timing when the deposit for all the participants is completed. The processing in steps S37 and S38 is performed independently of the processing in step S36. Therefore, the processing sequence is not limited to the sequence described here.

In the wallet server 2 that has received the payment completion notification from the first server 5, the control unit 21 updates the group information 234 (step S39), and transmits the deposit completion notification of the additional collection to the first terminal 3 and the second terminal 4 through the communication unit 22 (step S40).

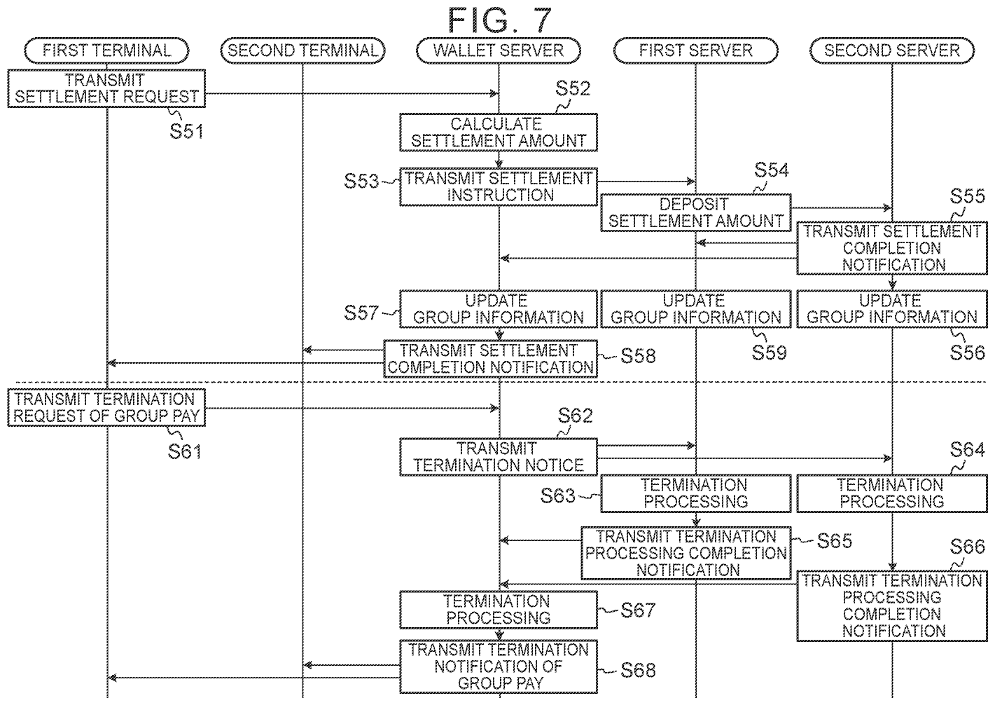

Next, the outline of settlement processing executed by the wallet system 1 using the group pay and termination processing of the group pay will be described with reference to the sequential diagram of FIG. 7. In FIG. 7, similar to FIG. 3, it is assumed that the second server 6 is a server that handles the payment means used by the second terminal 4 for making payment using the group pay. Further, for convenience of explanation, one of the second terminals 4 will also be used here as a representative.

First, the organizer of the group transmits a settlement request of the group pay to the wallet server 2 using the first terminal 3 (step S51).

In the wallet server 2 that has received the settlement request, the control unit 21 calculates a settlement amount based on the balance included in the group information 234 (step S52). Specifically, the control unit 21 calculates a uniform settlement amount for each member of the group.

After that, the control unit 21 transmits a settlement instruction to the first server 5 via the communication unit 22 (step S53). The settlement instruction above includes information on the settlement amount.

The deposit and withdrawal processing unit 511 of the first server 5 that has received the settlement instruction executes authentication based on the settlement instruction. When the authentication is successful, the deposit and withdrawal processing unit 511 deposits the settlement amount to the second server 6 via the communication unit 22 (step S54).

In the second server 6, when the deposit from the first server 5 is completed, the control unit 61 transmits a settlement completion notification to the wallet server 2 and the first server 5 via the communication unit 62 (step S55) and updates the group information 634 (step S56).

The control unit 21 of the wallet server 2 that has received the settlement completion notification from the second server 6 updates the group information 234 (step S57), and transmits the settlement completion notification to the first terminal 3 and the second terminal 4 (step S58).

The control unit 51 of the first server 5 that has received the settlement completion notification from the second server 6 updates the group information 534 (step S59). The group information is updated independently on each server. Therefore, the processing sequence is not limited to the sequence described here.

Subsequently, with reference to FIG. 7, processing when the group pay is terminated after the settlement is completed will be described. First, when the input unit 34 of the first terminal 3 receives a termination request of the group pay, the control unit 31 transmits the termination request to the wallet server 2 via the communication unit 32 (step S61).

In the wallet server 2 that has received the termination request, the control unit 21 executes authentication. When the authentication is successful, a termination notice of the group pay is transmitted to the first server 5 and the second server 6 (step S62).

The control unit 51 of the first server 5 and the control unit 61 of the second server 6 that have received the termination notice executes the termination processing by deleting the corresponding group information 534 and group information 634, respectively (steps S63, S64). The steps S63 and S64 are executed independently from each other. Therefore, the processing sequence is not particularly limited.

After the steps above, the control unit 51 and the control unit 61 transmit a termination processing completion notification to the wallet server 2 via the communication units 52, 62, respectively (steps S65 and S66). The steps S65 and S66 are executed independently from each other. Therefore, the processing sequence is not particularly limited.

In the wallet server 2 that has received the termination processing completion notification from the first server 5 and the second server 6, the control unit 21 deletes the corresponding group information 234 and terminates the group pay (step S67). After the step above, the control unit 21 transmits the termination notification of the group pay to the first terminal 3 and the second terminal 4 via the communication unit 22 (step S68).

When the group pay is not to be terminated, the first server 5 may store the balance as carry-forward money without executing settlement of the balance. Further, the wallet server 2 that has received the settlement request may automatically execute the termination processing of the group pay after the settlement is completed.

According to the embodiment of the present disclosure described above, when the first terminal receives the creation request of the group pay for making a payment by the electronic money using the first terminal and the second terminal that are respectively associated with the organizer and the participant of the group, the group pay is created in the wallet and the deposit request to the first server designated based on the creation request is transmitted to the second server designated in the registration information based on the registration information of the group pay received from the second terminal. Therefore, payment when more than one person act in a group can be easily made using the group pay.

Further, according to the embodiment, the payment request is transmitted to the first server in accordance with the payment request received from the first terminal or the second terminal. Therefore, any member of the group can make a payment using the group pay.

Further, according to the embodiment, when the balance of the first server in the group pay falls below the predetermined amount, the additional collection request is sent to the second server. Therefore, inability to make a payment due to insufficient balance can be suppressed in advance.

Other Embodiments

Although the embodiment for carrying out the present disclosure has been described above, the present disclosure should not be limited only to the embodiment described above. For example, in a situation in which the participants in the group may vary for each payment, information on the participants at the time of payment may be added to the payment request, and at the time of settlement, the control unit 21 of the wallet server 2 may calculate the settlement amount in accordance with a participation status of each member of the group for each payment. Consequently, each member of the group can receive the settlement amount in which a purchase history of the member of the group is reflected.

Further, the control unit 21 may calculate the settlement amount by weighting the settlement amount differently for each member of the group at the time of settlement. As an example of weighting, a transportation cost when using the group pay in the case of going on a travel may be weighted in accordance with a distance from home to a destination. Further, in the case of going on a travel with renting a car, weighting may be performed based on a correlation between mileage and gasoline consumption of the car and the driver as long as the correlation can be obtained in a format of data.

Further, group information may be created with a user who is not registered in the wallet server 2 being a virtual user. The control unit 21 may execute settlement for the virtual user as a user equivalent to other registered users and then may transmit the settlement amount of the virtual user to the first terminal 3.

Further, in the creation request of the group pay, the initial collection amount may be able to be set individually for each member of the group.

Further, a plurality of terminals capable of executing a part of the processing of each server may be geographically distributed and arranged, and a technique of edge computing in which a terminal located close to the first terminal 3 and the second terminals 4 communicates with the first terminal 3 and the second terminals 4 when communicating with the first terminal 3 and the second terminals 4 may be applied.

Further effects and modifications can be easily derived by those skilled in the art. The broader aspects of the disclosure are not limited to the particular details and representative embodiments shown and described above. Accordingly, various modifications may be made without departing from the spirit or scope of the general inventive concept as defined by the appended claims and their equivalents.

What is claimed is:

1. A wallet server comprising a processor including hardware, wherein
the processor:
creates, when the processor receives a creation request of group payment means for making a payment by electronic money using a first terminal and a second terminal that are associated with an organizer and a participant of a group, respectively, the group payment means in a wallet in which a plurality of payment means is registrable; and
outputs a deposit request to a first server designated in the creation request, based on registration information of the group payment means acquired from the second terminal, to a second server designated in the registration information.

2. The wallet server according to claim 1, wherein the processor outputs a payment request to the first server in accordance with a payment request acquired from the first terminal or the second terminal.

3. The wallet server according to claim 1, wherein the processor outputs an additional collection request to the second server when a balance of the group payment means in the first server falls below a predetermined amount.

4. The wallet server according to claim 1, wherein
the processor:
outputs a termination notice of the group payment means to the first server and the second server in accordance with a termination request of the group payment means acquired from the first terminal;
executes termination processing when the processor acquires a termination processing completion notification from the first server and the second server; and
outputs a termination notification to the first terminal and the second terminal after the termination processing is completed.

5. The wallet server according to claim 4, wherein
the processor:
calculates a settlement amount of a member of the group based on a balance of the group payment means in accordance with the termination request; and
outputs the termination notice including a settlement instruction based on the settlement amount to the first server.

6. The wallet server according to claim 1, wherein
the processor:
calculates a settlement amount of a member of the group based on a balance of the group payment means in accordance with a settlement request acquired from the first terminal; and
outputs a settlement instruction based on the settlement amount to the first server.

7. The wallet server according to claim 5, wherein the processor calculates the settlement amount in accordance with a participation status of the member of the group for each payment.

8. A wallet program, causing a processor including hardware to perform:
creating, when the processor receives a creation request of group payment means for making a payment by electronic money using a first terminal and a second terminal that are associated with an organizer and a participant of a group, respectively, the group payment means in a wallet in which a plurality of payment means is registrable; and
outputting a deposit request to a first server designated in the creation request, based on registration information of the group payment means acquired from the second terminal, to a second server designated in the registration information.

9. The wallet program according to claim 8, causing the processor to perform outputting a payment request to the first server in accordance with a payment request acquired from the first terminal or the second terminal.

10. The wallet program according to claim 8, causing the processor to perform outputting an additional collection request to the second server when a balance of the group payment means in the first server falls below a predetermined amount.

11. The wallet program according to claim 8, causing the processor to perform:
outputting a termination notice of the group payment means to the first server and the second server in accordance with a termination request of the group payment means acquired from the first terminal;
executing termination processing when the processor acquires a termination processing completion notification from the first server and the second server; and
outputting a termination notification to the first terminal and the second terminal after the termination processing is completed.

12. The wallet program according to claim 11, causing the processor to perform:
calculating a settlement amount of a member of the group based on a balance of the group payment means in accordance with the termination request; and
outputting the termination notice including a settlement instruction based on the settlement amount to the first server.

13. The wallet program according to claim 8, causing the processor to perform:
calculating a settlement amount of a member of the group based on a balance of the group payment means in accordance with a settlement request acquired from the first terminal; and
outputting a settlement instruction based on the settlement amount to the first server.

14. The wallet program according to claim 12, causing the processor to perform calculating the settlement amount in accordance with a participation status of the member of the group for each payment.

15. A wallet system comprising:
a wallet server including a first processor having hardware;
a first server including a second processor having hardware; and
a second server including a third processor having hardware, wherein
the first processor
creates, when the first processor receives a creation request of group payment means for making a payment by electronic money using a first terminal and a second terminal that are associated with an organizer and a participant of a group, respectively, the group payment means in a wallet in which a plurality of payment means is registrable; and
outputs a deposit request to a first server designated in the creation request, based on registration information of the group payment means acquired from the second terminal, to a second server designated in the registration information.

16. The wallet system according to claim 15, wherein the first processor outputs a payment request to the first server in accordance with a payment request acquired from the first terminal or the second terminal.

17. The wallet system according to claim 15, wherein the first processor outputs an additional collection request to the second server when a balance of the group payment means in the first server falls below a predetermined amount.

18. The wallet system according to claim 15, wherein:
the first processor outputs a termination notice of the group payment means to the first server and the second server in accordance with a termination request of the group payment means acquired from the first terminal;
each of the second processor and the third processor executes termination processing based on the termination notice, and outputs a termination processing completion notification to the wallet server; and
the first processor executes termination processing when the first processor acquires the termination processing completion notification from the first server and the second server, and outputs a termination notification to the first terminal and the second terminal.

19. The wallet system according to claim 18, wherein
the first processor:
calculates a settlement amount of a member of the group based on a balance of the group payment means in accordance with the termination request; and
outputs the termination notice including a settlement instruction based on the settlement amount to the first server.

20. The wallet system according to claim 15, wherein
the first processor:
calculates a settlement amount of a member of the group based on a balance of the group payment means in accordance with a settlement request acquired from the first terminal; and
outputs a settlement instruction based on the settlement amount to the first server.
